(19) United States
(12) Patent Application Publication
(10) Pub. No.: US 2012/0165067 A1
(43) Pub. Date: Jun. 28, 2012

(54) Mobile Telephone with Television Reception and Advertisement Delivery Control

(76) Inventors: Robert D. Tausworthe, Santa Clara, CA (US); Robert H. Freedman, San Francisco, CA (US)

(21) Appl. No.: 13/239,277

(22) Filed: Sep. 21, 2011

Related U.S. Application Data
(60) Provisional application No. 61/385,473, filed on Sep. 22, 2010.

(51) Int. Cl. H04W 88/02

(52) U.S. Cl. 455/556.1

(57) ABSTRACT

A mobile telephone includes a television receiver and a pre-loaded advertisement module including stored advertisements and advertisement display instructions. The advertisement display instructions control the display of the stored advertisements as television content is processed by the television receiver.

### CROSS REFERENCE TO RELATED APPLICATIONS

This application claims priority to U.S. Provisional Patent Application Ser. No. 61/385,473, filed Sep. 22, 2010, entitled, “Mobile Telephone with Television Reception and Advertisement Delivery Control”, the contents of which are incorporated herein by reference.

### FIELD OF THE INVENTION

This invention relates generally to mobile telephones. More particularly, this invention relates to a mobile telephone with television reception and advertisement delivery control.

### BACKGROUND OF THE INVENTION

A mobile telephone (also called a mobile, mobile phone, cellular phone, or cell phone) is an electronic device that provides two-way radio telecommunications over a cellular network of base stations. A mobile phone allows its user to make and receive telephone calls to and from the public telephone network, which includes other mobile phones and fixed line phones throughout the world.

In addition to providing traditional telephone functionality, modern mobile phones also support additional services, such as Short Message Service (SMS) messages (text messages), email, Internet access, gaming, cameras, music players and GPS. Low-end mobile phones are often referred to as feature phones, in contrast to high-end mobile phones that are referred to as smartphones.

Smartphones have enjoyed robust adoption in commercially advanced countries. There are ongoing efforts to increase the overall penetration of mobile phones throughout the world. These efforts are predicated upon providing feature phones that have appropriate attributes and price points for individuals in developing countries.

In view of the foregoing, it would be desirable to provide a mobile telephone that is tailored for widespread adoption, particularly in developing countries.

### SUMMARY OF THE INVENTION

A mobile telephone includes a television receiver and a pre-loaded advertisement module including stored advertisements and advertisement display instructions. The advertisement display instructions control the display of the stored advertisements as television content is processed by the television receiver.

### BRIEF DESCRIPTION OF THE FIGURES

The invention is more fully appreciated in connection with the following detailed description taken in conjunction with the accompanying drawings, in which:

FIG. 1 illustrates a mobile telephone configured in accordance with an embodiment of the invention.

FIG. 2 illustrates the processing of pre-load advertisements in accordance with an embodiment of the invention.

FIG. 3 illustrates the processing of dynamic advertisements in accordance with an embodiment of the invention.

Like reference numerals refer to corresponding parts throughout the several views of the drawings.

### DETAILED DESCRIPTION OF THE INVENTION

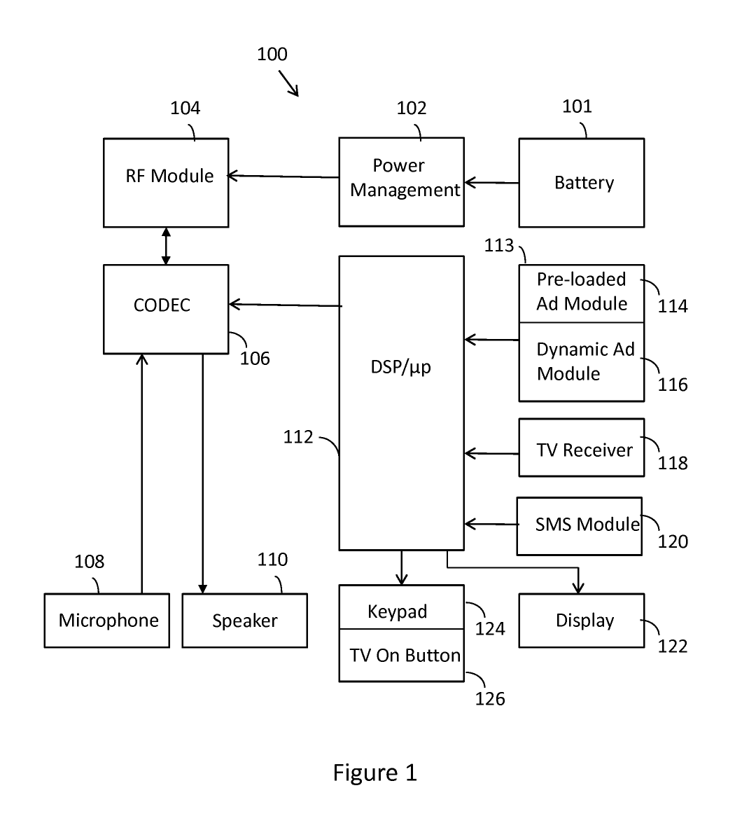

FIG. 1 illustrates a mobile phone 100 configured in accordance with an embodiment of the invention. The mobile phone 100 includes standard features, such as a battery 101, power management circuit 102, RF signal processing module 104 and an analog baseband/voiceband CODEC 106. The CODEC 106 receives input from the RF module 104 and a microphone 108 and provides output to a speaker 110.

The mobile phone 100 also includes a Digital Signal Processor (DSP) and/or a microprocessor 112. A memory 113 is connected to the processor 112. The memory 113 stores executable instructions to implement operations of the invention. In one embodiment, the memory 113 stores a pre-loaded advertisement module 114 and a dynamic advertisement module 116. As its name implies, the pre-loaded advertisement module 114 stores a set of advertisements that are loaded at the point of manufacture or another point in the supply chain prior to delivery to the consumer. The pre-loaded advertisement module 114 also stores a set of rules or instructions for displaying the advertisements.

The dynamic advertisement module 116 includes an advertisement display script that specifies the type and frequency of advertisements to be displayed. This script is periodically updated through the use of SMS signaling. As a result, ad content associated with the pre-loaded ad module 114 may be displayed in different ways and may be supplemented with updates.

The mobile phone 100 also includes a TV receiver 118 connected to the processor 112. The TV receiver 118 may be a chip sold by Telegent Systems, Sunnyvale, CA. Telegent Systems sells high-performance, single-chip products that enable the reception of free-to-air broadcast television in mobile handsets., laptops, and other portable devices. These chips support both analog and digital broadcast standards. The chips support multiple broadcast standards, including DVB-T, SECAM, PAL and NTSC. Content processed by the TV receiver 118 is displayed on display 122 of the mobile phone 100.

An SMS module 120 is also utilized. SMS is a text communication service component that uses standardized communications protocols that allow the exchange of short text messages between fixed line or mobile phone devices. The SMS module 120 is configured to support standard texting operations. In addition, the SMS module 120 is configured to process advertisement content, as discussed below.

The mobile phone 100 also includes a keypad 124. Unlike a standard keypad, the keypad 124 includes a TV on button 126, which invokes the pre-loaded advertisement module 114 and activates the TV receiver 118. Alternately, the TV may be invoked through a graphical user interface associated with display 122.

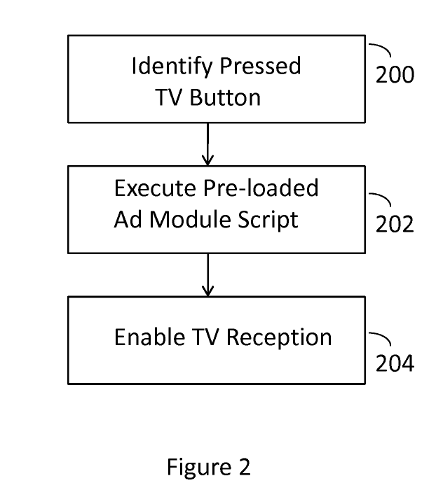

FIG. 2 illustrates processing operations associated with an embodiment of the invention. The keypad 124 is monitored to identify when the TV button 126 is pressed 200. This invokes the pre-loaded ad module 114. As a result, a pre-loaded ad module script 202 is executed. Pre-loaded ads are then displayed on the display 122. The pre-loaded ad module script 202 may specify the rotation of ads, time-based constraints, start/end campaign dates and other parameters.

Other forms of mobile TV advertising are associated with digital TV or streaming TV. These forms of content require a data plan for the mobile phone and also allow the delivered signal to include processing instructions for advertisements. One embodiment of the invention contemplates the processing of analog television signals that do not have this additional information to facilitate the advertisement display process. Instead, the pre-loaded ad module 114 controls ad delivery. In this way, the cost of the mobile phone may be subsidized through advertisements, which makes the purchase of such a mobile phone more practical in the developing world.

The pre-loaded ad module 114 may utilize a variety of rules to control ad rotation. For example, the module 114 may specify frequency settings (e.g., display ad X every Y times the TV button is pressed, but for no more than Z impressions). Alternately, the module 114 may specify start and end date constraints (e.g., start campaign on date X and end the campaign on date Y). Alternately, time constraints may be specified (e.g., do not display ads between X and Y pm). Any number of rules may be used in accordance with embodiments of the invention.

The final processing operation of FIG. 2 is to enable TV reception 204. Thus, in response to pressing the TV on button, a set of advertisements are displayed under the control of the pre-loaded advertisement module. Afterwards, TV reception is supplied. The TV reception 204 may be accompanied by banner ads, as specified by the pre-loaded ad module 114.

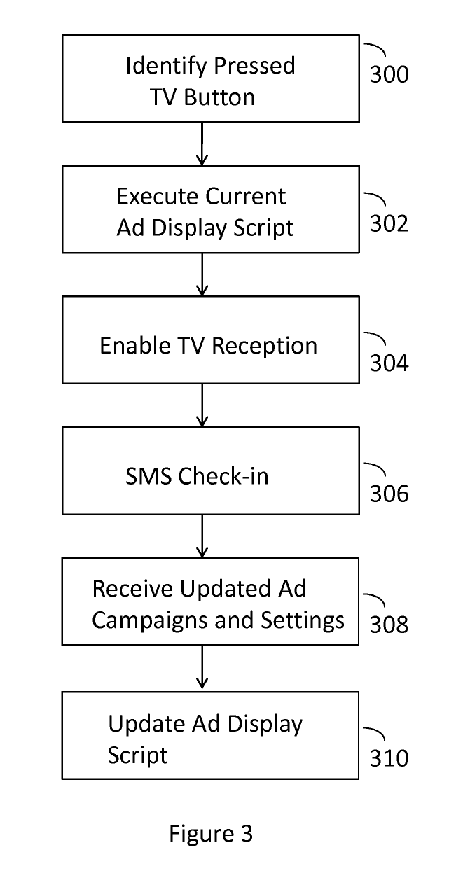

FIG. 3 illustrates processing operations associated with another embodiment of the invention. The first processing operation is to identify when the TV button is pressed 300. In response to this event, the current ad display script is executed 302. The current ad display script is maintained by the dynamic ad module 116. TV reception is then enabled 304. Afterwards, an SMS check-in is performed. In particular, the dynamic ad module 116 coordinates with the SMS module to check-in with a specified address associated with a backend server. The backend server is typically accessed through an SMS gateway.

The check-in operation may include the passing of mobile phone use data. For example, this data may specify how frequently the mobile phone is used, when the mobile phone is used, what TV content has been viewed, what ads have been viewed and the like. Thereafter, the mobile phone receives updated ad campaigns and settings. That is, the backend server uses SMS messaging to provide updated ads and setting controls. The setting controls may include rules regarding what ads to display, the frequency that the ads should be displayed, TV content that the ads should accompany, and the like. This information is processed by the dynamic ad module 116 to update the current ad display script 310.

The SMS data channel serves as a separate data channel to control ad delivery and display instructions. This stands in contrast to unified data channels with data plans that allow instructions of this type to be delivered with the TV content. With the invention, such a data plan is not required. This is advantageous because such data plans are typically associated with smartphones and related higher end products that may be prohibitively expensive for individuals in the developing world. Thus, the invention allows a relatively low cost feature phone to mimic the operation of its more expensive counterparts. For example, the SMS data channel may be used to deliver an electronic program guide on a non-data plan phone. The dynamic ad module 116 may the coordinate the display of the electronic program guide on the display 122.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A mobile telephone, comprising:
a television receiver; and
a pre-loaded advertisement module including stored advertisements and advertisement display instructions, wherein the advertisement display instructions control the display of the stored advertisements as television content is processed by the television receiver.

2. The mobile telephone of claim 1, wherein the stored advertisements are displayed prior to displaying the television content processed by the television receiver.

3. The mobile telephone of claim 1, wherein the stored advertisements are displayed concurrently with displaying the television content processed by the television receiver.

4. The mobile telephone of claim 1 further comprising a keypad with a TV on button to invoke the pre-loaded advertisement module.

5. The mobile telephone of claim 1 further comprising a dynamic advertisement module with a current advertisement display script.

6. The mobile telephone of claim 5 further comprising an SMS module to facilitate SMS communications.

7. The mobile telephone of claim 6 wherein the SMS module operates with the dynamic advertisement module to deliver advertisement viewing data from the mobile telephone.

8. The mobile telephone of claim 6 wherein the SMS module receives updated advertisement campaigns and settings.

9. The mobile telephone of claim 8 wherein the dynamic advertisement module processes the updated advertisement campaigns and settings to form an updated advertisement display script.

10. The mobile telephone of claim 6 wherein the SMS module receives an electronic program guide.

11. The mobile telephone of claim 10 wherein the dynamic advertisement module coordinates the display of the electronic program guide.
